(19) United States
(12) Patent Application Publication
(10) Pub. No.: US 2009/0117930 A1
(43) Pub. Date: May 7, 2009

(54) PUSH-TO-COMMUNICATE SERVICE IN A CELLULAR COMMUNICATION SYSTEM

(75) Inventors: Craig J. Purcell, Swindon (GB); Mehdi Witwit, Swindon (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/995,163

(22) PCT Filed: Jun. 23, 2006
(86) PCT No.: PCT/US2006/024614

§ 371 Date: Jun. 18, 2008

(30) Foreign Application Priority Data
Sep. 28, 2005 (GB) 0519802.3

(51) Int. Cl. H04B 7/00

(52) U.S. Cl. 455/518; 709/219

(57) ABSTRACT

A cellular communication system comprises a push-to-communicate server (117) which comprises a PTC controller (203) which supports a push-to-communicate service for a group of remote terminals (101, 103, 115). The remote terminals (101, 103, 115) measure a radio quality indication and transmit this to the push-to-communicate server (117) where a quality processor (205) determines a radio quality characteristic for the remote terminals (101, 103, 115) based on the received measurements. The radio quality characteristic for the remote terminal (101, 103, 115) relates to an air interface communication link which supports the push-to-communicate service for that remote terminal (101, 103, 115). The PTC controller (203) controls a transmit controller (207) to transmit the radio quality characteristic to at least one other remote terminal (101, 103, 115) of the group of remote terminals (101, 103, 115). When receiving the radio quality indication for another remote terminal (101, 103, 115), a remote terminal (101, 103, 115) may present a perceived end-quality indication for the other remote terminal (101, 103, 115) to the user.

### FIELD OF THE INVENTION

The invention relates to a push-to-communicate service in a cellular communication system and in particular, but not exclusively, to a push-to-talk or push-to-video service in a GSM cellular communication system.

### BACKGROUND OF THE INVENTION

In a cellular communication system a geographical region is divided into a number of cells each of which is served by a base station. The base stations are interconnected by a fixed network which can communicate data between the base stations. A mobile station is served via a radio communication link by the base station of the cell within which the mobile station is situated.

As a mobile station moves, it may move from the coverage of one base station to the coverage of another, i.e. from one cell to another. As the mobile station moves towards a base station, it enters a region of overlapping coverage of two base stations and within this overlap region it changes to be supported by the new base station. As the mobile station moves further into the new cell, it continues to be supported by the new base station. This is known as a handover or handoff of a mobile station between cells.

A typical cellular communication system extends coverage over typically an entire country and comprises hundreds or even thousands of cells supporting thousands or even millions of mobile stations. Communication from a mobile station to a base station is known as uplink, and communication from a base station to a mobile station is known as downlink.

The fixed network interconnecting the base stations is operable to route data between any two base stations, thereby enabling a mobile station in a cell to communicate with a mobile station in any other cell. In addition, the fixed network comprises gateway functions for interconnecting to external networks such as the Public Switched Telephone Network (PSTN), thereby allowing mobile stations to communicate with landline telephones and other communication terminals connected by a landline. Furthermore, the fixed network comprises much of the functionality required for managing a conventional cellular communication network including functionality for routing data, admission control, resource allocation, subscriber billing, mobile station authentication etc.

Currently, the most ubiquitous cellular communication system is the 2nd generation communication system known as the Global System for Mobile communication (GSM). Further description of the GSM TDMA communication system can be found in ‘The GSM System for Mobile Communications’ by Michel Mouly and Marie Bernadette Pautet, Bay Foreign Language Books, 1992, ISBN 2950719007.

3rd generation systems are currently being rolled out to further enhance the communication services provided to mobile users. One such system is the Universal Mobile Telecommunication System (UMTS), which is currently being deployed. Further description of CDMA and specifically of the Wideband CDMA (WCDMA) mode of UMTS can be found in ‘WCDMA for UMTS’, Harri Holma (editor), Antti Toskala (Editor), Wiley & Sons, 2001, ISBN 0471486876.

To further enhance the services and performance of cellular communication systems, the technical specifications are continuously amended and enhanced. One such service that has been introduced to cellular communication systems is push-to-talk services known from Professional Mobile Radio (PMR) systems such as the TETRA (TErrestrial Trunked RAdio) communication system. Push-to-talk services provide a number of features and services for managing and controlling group calls as well as for managing the membership of these groups. Thus, push-to-talk systems provide services for making group calls wherein e.g. a voice message is quickly and efficiently relayed to a specific group of remote units and furthermore provides features for managing the membership of different groups, priorities of different groups etc.

Furthermore, the principles of push-to-talk services have been enhanced to other communication types than simply voice communication. For example, the principles may also be applied to communication of other audio or video and may in particular be used for streaming of audio or video sequences. The services may collectively be referred to as push-to-communicate services. Push-to-communicate services tend to employ single duplex communication wherein communication is in only one direction at a given time i.e. each terminal involved in a push-to-communicate either transmits or receives but does not do both simultaneously.

The current state of the art for push-to-communicate applications involve sending information (speech, video etc) to an individual or group represented in a user's group list (sometimes referred to as a buddy list). The signalling and setup of real-time media streams typically uses an acknowledged mode process to ensure some amount of reliability. However, the delivery of the media stream itself is typically unreliable and there is no guarantee that the transmitted data is accurately received at all intended destinations. Thus, there are no guarantees of the quality of the media stream received by the target users and the transmitting user can only assume that the media stream is received with sufficient quality but has no certainty that the individual recipient is even able to decode the received media stream. This problem is increased in group call scenarios where the individual members of the group may receive the media stream with substantially different qualities.

Hence, an improved push-to-communicate system would be advantageous and in particular a system allowing for improved performance, increased information feedback, improved control of an end quality and/or an improved user experience would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided a cellular communication system comprising: means for supporting a push-to-communicate service for a group of remote terminals; determining means for determining a radio quality characteristic for an air interface communication link of a first remote terminal of the group of remote terminals; the air interface communication link supporting the push-to-communicate service for the first remote terminal; and first transmitting means for transmitting the radio quality characteristic to a second remote terminal of the group of remote terminals.

The invention may allow improved push-to-communicate services. Improved feedback to a source may be provided and the push-to-communicate service may be controlled or optimized depending on the quality of the quality of the signals received by the group of remote terminals.

The inventors of the current invention have realized that an accurate measure of the end quality perceived by receiving uses of the group can be provided to other users in a push-to-communicate group using the radio quality characteristic of an air interface communication link supporting the push-to-communicate service. The radio quality characteristic can be a radio quality characteristic which is automatically determined and/or is also determined and used for other purposes. Thus, a low complexity may be achieved in many embodiments.

The means for determining the radio quality characteristic can simply receive the radio quality characteristic from the different source or may e.g. calculate the radio quality characteristic in response to a suitable algorithm.

According to an optional feature of the invention, the first transmitting means is arranged to transmit the radio quality characteristic of the first remote terminal to all other remote terminals of the group of terminals.

This may provide a practical, easy to implement and/or efficient way of distributing the radio quality characteristic. Additionally or alternatively, it may allow the information of the radio quality characteristic to be used in all remote terminals of the group. In particular, it may provide information to all users in a group of the quality perceived by other users of the group.

According to an optional feature of the invention, the second remote terminal comprises: storage means for storing data associated with the group of remote terminals; and means for updating a stored characteristic for the second remote terminal in response to the radio quality characteristic.

The invention may allow information of the perceived quality by other users in the group to affect stored characteristics for the users. This may allow improved performance and/or may allow an improved customization and/or adaptation to the different conditions experienced by different users. Future, push-to-communicate services may be optimized to reflect previously experienced conditions for the individual remote terminals. For example, a typical or average perceived quality for different users in a group may be stored and used to select transmission characteristics for future push-to-communicate services.

According to an optional feature of the invention, the second remote terminal comprises means for presenting an indication of the radio quality characteristic to a user.

The invention may provide improved information to users of the push-to-communicate service group of the quality experienced by other users in the group. Hence, the users may take the actual conditions experienced by other users into account.

According to an optional feature of the invention, the second remote terminal comprises: means for receiving radio quality characteristics from a plurality of the remote terminals of the group of remote terminals; and means for presenting communication quality indications for each of the plurality of remote terminals, the communication quality indication being determined in response to the radio quality characteristics.

This may allow improved information to the user thereby allowing the user to adapt to the conditions experienced by other users.

According to an optional feature of the invention, the second remote terminal comprises a display and the means for presenting is arranged to display a visual representation for each of the plurality of remote terminals with a characteristic of the visual representation of each of the plurality of terminals being dependent on the radio quality characteristic of that remote terminal.

This may provide an efficient, reliable and/or user friendly information to a user of the conditions for a group push-to-communicate service. The feature may in particular provide user feedback which is suitable for the limitations of a typical remote terminal.

According to an optional feature of the invention, the first remote terminal comprises the determining means and means for including the radio quality characteristic in a user data packet.

This may provide a particularly efficient means of communicating the radio quality characteristic. A practical and low complexity implementation which may be suitable for many existing communication systems may be achieved. The feature may allow the invention to be introduced to existing communication systems with minimal modifications to existing standards and/or existing equipment. The feature may for example be suitable for communication of the radio quality characteristic during an ongoing push-to-communicate communication of user data. The user data packet may specifically be a user data packet supporting the push-to-communicate communication.

According to an optional feature of the invention, the first remote terminal comprises the determining means and means for including the radio quality characteristic in a signaling data packet.

This may provide a particularly efficient means of communicating the radio quality characteristic. A practical and low complexity implementation which may be suitable for many existing communication systems may be achieved. The feature may allow the invention to be introduced to existing communication systems with minimal modifications to existing standards and/or existing equipment. The feature may for example be suitable for communication of the radio quality characteristic during an ongoing push-to-communicate signaling communication. The signaling data packet may specifically be a data packet supporting a push-to-communicate call setup process. This signaling data packet may for example be a control data packet.

According to an optional feature of the invention, the first remote terminal comprises the determining means and means for including the radio quality characteristic in a Session Initiation Protocol (SIP) data packet.

This may provide a particularly efficient means of communicating the radio quality characteristic. The feature may in particular allow an efficient communication compatible with current specifications for a push-to-communicate service of a GSM cellular communication system. In particular the feature may allow efficient communication during setup of the push-to-communicate service.

According to an optional feature of the invention, the first remote terminal comprises the determining means and means for including the radio quality characteristic in a Real Time Protocol (RTP) data packet.

This may provide a particularly efficient means of communicating the radio quality characteristic. The feature may in particular allow an efficient communication compatible with current specifications for a push-to-communicate service of a GSM cellular communication system. In particular the feature may allow efficient communication during the push-to-communicate service.

According to an optional feature of the invention, the first remote terminal comprises the determining means and means for including the radio quality characteristic in an idle mode link maintenance transmission.

This may allow efficient communication of the radio quality characteristic and in particular may allow efficient communication during idle mode operation. The idle mode link maintenance transmission may specifically be a “keep alive” message.

According to an optional feature of the invention, the cellular communication system further comprises: a push-to-communicate server comprising the means for supporting the push-to-communicate service and the first transmitting means; and wherein the first remote terminal comprises the determining means and second transmitting means for transmitting the radio quality characteristic to the push-to-communicate server.

This may facilitate implementation and/or may provide high-performance. The feature may allow compatibility with existing systems using a push-to-communicate server for managing push-to-communicate services.

According to an optional feature of the invention, the push-to communicate server comprises means for requesting the radio quality characteristic from first remote terminal.

This may allow an efficient and/or low complexity system with high-performance. In particular, it may facilitate operation and management of the generation and/or transmission of the radio quality characteristic.

According to an optional feature of the invention, the second remote terminal is arranged to transmit the radio quality characteristic in response to receiving an invitation to join a push-to-communicate service.

This may allow an efficient and/or low complexity system with high-performance. In particular, it may facilitate operation and management of the generation and/or transmission of the radio quality characteristic. The invitation to join the push-to-communicate service may be transmitted from the push-to-communicate server. The feature may in particular allow information of the end-quality at the second remote terminal to be provided with little delay.

According to an optional feature of the invention, the second remote terminal is arranged to transmit the radio quality characteristic in response to receiving a presence update message.

This may allow an efficient and/or low complexity system with high-performance. In particular, it may facilitate operation and management of the generation and/or transmission of the radio quality characteristic. The presence update message may be transmitted from the push-to-communicate server or e.g. from another remote terminal of the group of remote terminals.

According to an optional feature of the invention, the radio quality characteristic comprises a radio link error rate parameter.

This may be a particularly suitable radio quality characteristic and may in particular provide a highly accurate measure of the perceived end-quality of the second remote terminal. The radio link error rate parameter may specifically be a bit error rate, a block error rate or a frame error rate measured for the air interface communication link.

According to an optional feature of the invention, the cellular communication system is a Global System for Mobile communication cellular communication system.

The invention may allow improved push-to-communicate services in a GSM cellular communication system. The radio link characteristic may specifically comprise an RXQUAL parameter.

According to another aspect of the invention, there is provided an apparatus for supporting a push-to-communicate service in a cellular communication system, the apparatus comprising: means for setting up a push-to-communicate service for a group of remote terminals; means for receiving a radio quality characteristic from a first remote terminal of the group of remote terminals; and means for transmitting the radio quality characteristic to a second remote terminal of the group of remote terminals.

According to another aspect of the invention, there is provided a remote terminal for a cellular communication system; the remote terminal comprising: means for supporting a push-to-communicate service with at least one other remote terminal; means for receiving a radio quality characteristic from the at least one other remote terminal, the radio quality characteristic being indicative of a quality of an air interface communication link supporting the at least one other remote terminal; and means for generating a user presentation in response to the radio quality characteristic.

According to another aspect of the invention, there is provided a method of operation in a cellular communication system, the method comprising: supporting a push-to-communicate service for a group of remote terminals; determining a radio quality characteristic for an air interface communication link of a first remote terminal of the group of remote terminals; the air interface communication link supporting the push-to-communicate service for the first remote terminal; and transmitting the radio quality characteristic to a second remote terminal of the group of remote terminals.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 is an illustration of a cellular communication system in accordance with the present invention;

FIG. 2 illustrates a PTC server 117 in accordance with some embodiments of the invention;

FIG. 3 illustrates a remote terminal in accordance with some embodiments of the invention;

FIG. 4 illustrates an example of a push-to-communicate service in accordance with some embodiments of the invention.

### DETAILED DESCRIPTION OF SOME EMBODIMENTS OF THE INVENTION

The following description focuses on embodiments of the invention applicable to a GSM cellular communication system. However, it will be appreciated that the invention is not limited to this application but may be applied to many other cellular communication systems including for example 3^{rd} Generation cellular communication systems such as UMTS.

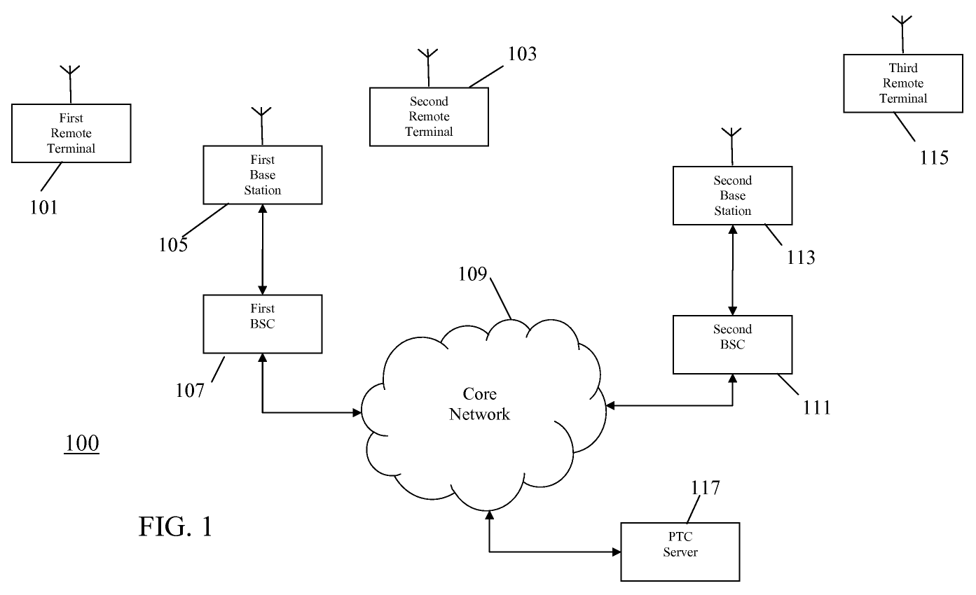

FIG. 1 illustrates an example of a cellular communication system in accordance with some embodiments of the invention.

In the example of FIG. 1, a first remote terminal 101 and a second remote terminal 103 are in a first cell supported by a first base station 105.

A remote terminal can be a user equipment such as a 3rd Generation User Equipment (UE), a communication unit, a subscriber unit, a mobile station, a communication terminal, a mobile phone, a personal digital assistant, a laptop computer, an embedded communication processor or any physical, functional or logical communication element which is capable of communicating over the air interface of the cellular communication system.

The first base station 105 is coupled to a first Base Station Controller (BSC) 107. A BSC performs many of the control functions related to the air interface including radio resource management and routing of data to and from appropriate base stations.

The first BSC 107 is coupled to a core network 109. A core network interconnects BSCs and is operable to route data between any two BSCs, thereby enabling a remote terminal in a cell to communicate with a remote terminal in any other cell. In addition, a core network comprises gateway functions for interconnecting to external networks such as the Public Switched Telephone Network (PSTN), thereby allowing remote terminals to communicate with landline telephones and other communication terminals connected by a landline. Furthermore, the core network comprises much of the functionality required for managing a conventional cellular communication network including functionality for routing data, admission control, resource allocation, subscriber billing, remote terminal authentication etc. The core network can specifically comprise one or more Mobile Switching Centres (MSCs).

The core network 109 is further coupled to a second BSC 111 which is coupled to a second base station 113. The second base station 113 supports a third remote terminal 115.

In the example, the cellular communication system 100 further comprises a Push-To-Communicate (PTC) server 117. In contrast to a conventional communication service of a cellular communication system, a push-to-communicate service is characterised by employing a single duplex scheme wherein each remote terminal can instantly send text, video, images or other media to recipients using a single button push. The concept of presence is employed such that a central server maintains the state, such as “available”, “busy”, “not available” of each remote terminal, with this state information being relayed to other remote terminals. Remote terminal users therefore are aware of the status of other users before information is “pushed”. Within a conventional system the terminal user would need to poll the recipient before the status is known.

The most typical push-to-communicate service tends to be a push-to-talk service but services are known for other content such as for example for media streams. Specifically, the push-to-communicate service of FIG. 1 can be a push-to-video or push-to-audio service. In many systems, push-to-communicate services involve sending information, such as speech, video etc, to an individual or group represented in a user's group list (often referred to as a buddy list).

In the specific example of FIG. 1, the PTC server 117 supports a push-to-communicate service involving the first remote terminal 101, the second remote terminal 103 and the remote terminal 115. Specifically, the first remote terminal 101 can initiate a group called which the second remote terminal 103 and the third remote terminal 115 join. The first remote terminal 101 can proceed to transmit a video stream which is received by the second remote terminal 103 and the third remote terminal 115.

In push-to-communicate services, such as those specified for the GSM cellular communication system, the delivery of the media stream itself is unreliable and there are no guarantees of the quality of the media stream received by the target users. Thus, the first remote terminal transmits a video stream that, due to communication errors, may differ substantially from that transmitted.

In conventional systems, the user of the first remote terminal 101 does not have any information of how the video stream is received at the destinations. Indeed, the user of the first remote terminal 101 does not even know if the recipients are able to hear or see the intended media stream. This problem is increased in group call scenarios where some members of the group can receive better quality media streams than others. For example, the communication link from the first base station to the second remote terminal 103 can be substantially more reliable than the communication link from the second base station 113 to the third remote terminal 115 and accordingly the user of the second remote terminal 103 can receive the media stream at a significantly better quality than the user of the remote third terminal 115.

The cellular communication system of FIG. 1 comprises functionality for communicating radio quality information for a communication link of a receiving push-to-communicate remote terminal to the transmitting remote terminal. In the specific example, a radio quality characteristic of the air interface communication link between the first base station 105 and the second remote terminal 103 and of the communication link between the second base station 113 and the remote terminal 115 is transmitted to the first remote terminal 101.

As the quality of the radio links tend to be the main parameter determining the resulting perceived quality by the users, the communication system of FIG. 1 provides accurate information to transmitting remote terminal of the perceived quality at the receiving remote terminals. Thus, a substantially improved information feedback and user experience can be achieved.

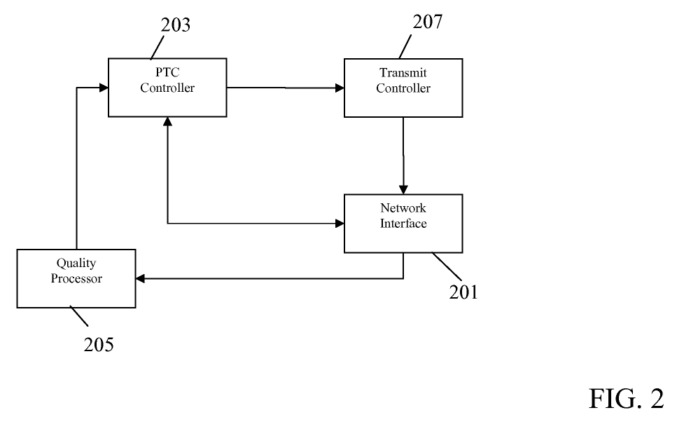

FIG. 2 illustrates an example of the PTC server 117 in accordance with some embodiments of the invention.

The PTC server 117 comprises a network interface 201 which interfaces to the core network 109.

The PTC server 117 furthermore comprises PTC controller 203 which is coupled to the network interface 201. The PTC controller 203 is operable to set up and support a push-to-communicate service for the remote terminals. In particular, the PTC controller 203 sets up and supports the ongoing push-to-communicate group call between the first remote terminal 101, the second remote terminal 103 and the third remote terminal 115. Methods, procedures and algorithms for supporting a push-to-communicate service are known to the person skilled in the art and will for brevity not be described further herein.

The PTC server 117 furthermore comprises a quality processor 205 which is coupled to the PTC controller 203 and the network interface 201. The quality processor 205 is operable to determine a radio quality characteristic for an air interface communication link of one are more of the remote terminals of the group of remote terminals involved in the push-to-communicate service. In the specific example, the quality processor 205 determines a radio link characteristic for the three remote terminals 101, 103, 115.

In the specific example, each of the remote terminals 101, 103, 115 measures the radio quality characteristic in the form of an air interface error rate when receiving push-to-communicate services. The measured error rate is then transmitted to the PTC server 117 in suitable messages. When these messages are received by the network interface 201, they are forwarded to the quality processor 205. Thus, in the example, the quality processor 205 determines the radio quality characteristic by receiving an error rate indication from the remote terminals 101, 103, 115. The radio quality characteristic determined by the quality processor 205 can be determined as the function of the received error rate or the received error rate can be used directly.

In a specific example of a GSM cellular communication system, the radio quality characteristic can specifically be the RXQUAL which is reported to the base station by a remote terminal in GSM communication systems. The RXQUAL is generally used for handover decisions but can also be used for improving the push-to-communicate service in accordance with the described example.

When the quality processor 205 determines a radio quality characteristic, this is fed to the PTC controller 203. The PTC server 117 furthermore comprises the transmit controller 207. When the PTC controller 203 receives a radio quality characteristic from one of the remote terminals in the group it controls the transmit controller to transmit this radio quality characteristic to the other remote terminals in the group. Thus, in the specific example, the remote terminal 115 determines a bit error rate for a push-to-communicate communication on the communication link between the second base station 113 and the remote terminal 115. The bit error rate is then transmitted to the PTC server 117 where it is fed to the PTC controller 203 via the quality processor 205.

The PTC controller 203 then controls the transmit controller 207 to transmit the bit error rate to the first remote terminal 101 and the second remote terminal 103. It will be appreciated that in some embodiments, the radio quality characteristic may only be transmitted to some remote terminals of the group. For example, the radio quality characteristic may only be transmitted to the transmitting remote terminal.

When receiving the radio quality characteristic for another remote terminal, a remote terminal can modify its operation and/or present an indication to the user of the perceived quality at the other remote terminals in the group.

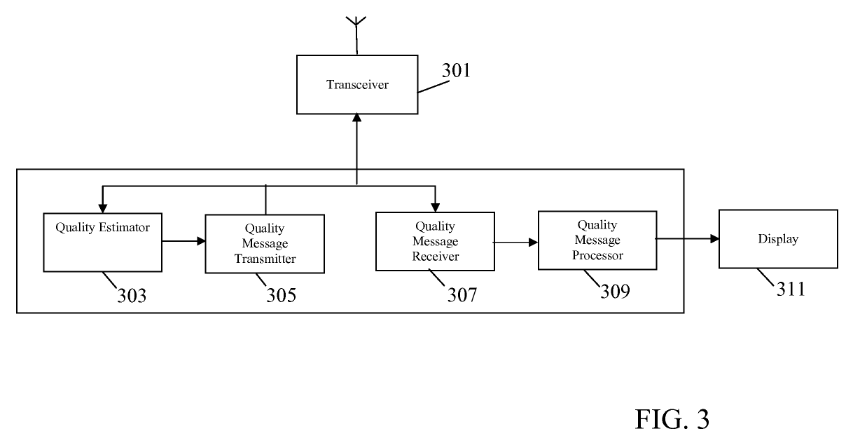

FIG. 3 illustrates a remote terminal in accordance with some embodiments of the invention. The figure specifically illustrates the remote terminals 101, 103, 115 of FIG. 1, and will be described with reference to this figure.

The remote terminal comprises a transceiver 301 which communicates with the serving base station over the air interface in accordance with the Technical Specifications of the GSM cellular communication system.

The remote terminal furthermore comprises a quality estimator 303 which is coupled to the transceiver 301 and which is operable to determine a radio quality characteristic of the communication link between the serving base station and the remote terminal. Specifically, the quality estimator 303 can determine the bit error rate for push-to-communicate transmissions to the remote terminal.

The quality estimator 303 is coupled to a quality message transmitter 305 which is further coupled to the transceiver 301. The determined bit error rate is fed from the quality estimator 303 to the quality message transmitter 305. The quality message transmitter 305 is arranged to transmit the radio quality characteristic to the PTC server 117. Specifically, the quality message transmitter 305 can generate a suitable message comprising the determined bit error rate, address the message to the PTC server 117 and control the transceiver 301 to transmit the message to the serving base station from where it will be routed to the PTC server 117.

The remote terminal 300 furthermore comprises at quality message receiver 307 which is coupled to the transceiver 301. The quality message receiver 307 receives the radio quality characteristics from other remote terminals of the push-to-communicate group. For example, the quality message receiver 307 of the first remote terminal 101 can receive the radio quality characteristics from the second remote terminal 103 and from the third remote terminal 115. The quality message receiver 307 is coupled to a quality message processor 309 which is arranged to receive an indication of the radio quality for the different remote terminals 103, 115 from the quality message receiver 307.

The quality message processor 309 is coupled to a display 311 which is arranged to display visual indications to a user of a remote terminal.

In the example of FIG. 3, the quality message processor 309 controls the display 311 to display an initial indication for each of the remote terminals involved in the push-to-communicate group communication. Thus, in the example of FIG. 1, the quality message processor 309 of the first remote terminal 101 can specifically generate a display icon for the second remote terminal 103 and the third remote terminal 115. Furthermore, the quality message processor sets the characteristic of the display icon in response to the radio quality characteristic received from the corresponding remote terminal 103, 115.

For example, the display 311 can show an icon for each of the remote terminals 103, 115 and the quality message processor 309 can adjust a colour or shading of the icon depending on the value of the radio quality characteristic. As a specific example, if the quality message receiver 307 receives an indication that the bit error rate is below a first threshold generally associated with negligible performance degradation, the corresponding icon can be set to a green colour by the quality message processor 309. If the bit error rate is above the first threshold but below a second threshold generally associated with noticeable but acceptable performance degradation, the corresponding icon can be set to a yellow colour. If the bit error rate is above the second threshold, the performance can be considered unacceptable and the icon can be set to a red colour.

Thus, the user of one remote terminal can be provided with a very clear and easy to interpret indication of the end-quality perceived by the users of the other remote terminals. Accordingly, a push-to-communicate service can be provided be improved to allow enable a user to control and adapt to the actual conditions experienced by other users in the group. Furthermore, the system can be provided by a simple and low complexity implementation of a push-to-communicate server and the modifications and alterations to the remote terminals and/or the Technical Specifications of the communication system can be kept low.

It will be appreciated, that the indication of a radio quality characteristic for a remote terminal need not be a visual indication but can for example be an audio indication. For example in response to a key entry by the user, a synthesized voice can provide a presentation of the radio quality characteristic for a given remote terminal.

It will also be appreciated, that the individual remote terminal can only present an indication of a subset of the remote terminals of the group. For example, the user can select one or more remote terminals for which the quality indication is provided.

In some embodiments, the received radio quality characteristic can be indicated directly. For example, the bit error rate for each remote terminal can be presented on the display 311 using alphanumeric characters.

It will also be appreciated that the radio quality characteristic received from the different remote terminals can alternatively or additionally be used for other purposes than for presentation to the user.

For example, the remote terminal can potentially optimize its performance and/or operation in response to the received radio quality characteristic.

In some embodiments, the remote terminal can comprise a buddy list of other remote terminals/users belonging to the push-to-communicate group. For each remote terminal in the buddy list, the remote terminal can store a characteristic which is determined from the received radio quality indications from the remote terminal. This characteristic can be retrieved and used for determining parameters or characteristics for a future operation.

As an example, the remote terminal can receive a bit error rate characteristic from other remote terminals during an ongoing push-to-communicate service. When the push-to-communicate service terminates, the average bit error rate for each remote terminal can be stored in the buddy list. When the remote terminal initiates a new push-to-communicate service involving one of these remote terminals, it can retrieve the average bit error rate achieved in the last push-to-communicate operation and can set one or more transmission characteristics in response to the retrieved characteristic. For example, the source encoding rate of the video stream can be set according to the expected average bit error rate.

It will be appreciated, that the quality message transmitter 305 can transmit the radio quality characteristic from the remote terminal at any suitable time and using any suitable means.

For example, during a push-to-communicate service, user data packets can be transmitted from the remote terminal 101 to the PTC server 117 and from the PTC server 117 to the other remote terminals 103, 115 of the push-to-communicate group. The quality message transmitter 305 of the first remote terminal 101 can be arranged to include the radio quality indication for the communication link between the serving base station 105 to the first remote terminal 101 in the user data packets. When receiving the user data packets, the PTC server 117 can extract the radio quality indication and distribute to the other remote terminals 103, 115 of the group. Specifically, the radio quality indication can be transmitted with the user data packets from the PTC server 117 to the remote terminals 103, 115. When receiving the user data packets, the quality message receiver 307 of the remote terminals 103, 115 can extract the radio quality indication from the user data packet. In this way, the remote terminals 103, 115 can easily and accurately be provided with information of the receive quality at the first remote terminal 101.

The quality message transmitter 305 can alternatively or additionally be arranged to transmit the radio quality characteristic in a signaling data packet. For example, a number of signaling messages can be exchanged between the first remote terminal 101 and the first base station 105, and the radio quality characteristic can be included or piggy-backed on one or more of these messages. As another example, a number of messages can be exchanged between the remote terminals 101, 103, 115 and the PTC server 117, and a radio quality characteristic can be included in one are more of these. For example, presence information can be exchanged in signaling messages between remote terminals 101, 103, 115 and the PTC server 117, and the measured bit error rate from the remote terminals can be embedded in the presence messages.

Alternatively or additionally, the quality message transmitter 305 can transmit the radio quality characteristic in idle mode link maintenance transmissions. Specifically, a push-to-communicate remote terminal is typically arranged to transmit keep-alive messages during idle mode in operation order to maintain the communication link. During idle mode operation, the radio quality indication can be embedded in such messages.

In particular, a GSM cellular communication system uses SIP (Session Initiation Protocol) messaging for call setup, control and media path establishment, and RTP (Real Time Protocol) to send a media stream. In such a system, the quality message transmitter 305 can e.g. be arranged to transmit the radio quality characteristic in SIP messages during call setup and in RTP messages during the following push-to-communicate media streaming.

In the system of FIG. 1, the quality message transmitters 305 can thus piggy-back radio link quality information onto return traffic to the PTC server 117 such that buddy lists of the remote terminals 101, 103, 115 can be updated to include quality information.

It will be appreciated that in some embodiments, the PTC server 117 can manage and maintain a dynamic record of each remote terminal's downlink radio quality. This information can then be periodically sent to each remote terminal on the call, by embedding the data in subsequent SIP/RTP downlink packets, or by using standard keep-alive messages.

It will also be appreciated, that the radio quality characteristic can be transmitted from the remote terminals or the PTC server at any suitable time and/or in response to any suitable event.

For example, the PTC server 117 can specifically request a radio quality characteristic from a remote terminal. When the remote terminal receives the request, the quality message transmitter 305 can embed the information in any suitable message which is then forwarded to the PTC server 117. The PTC server 117 can for example request the radio quality characteristic when a certain amount of time has passed since the last radio quality characteristic was received.

In some embodiments, the remote terminals can transmit the radio quality characteristic whenever messages are transmitted to the PTC server 117 and/or in response to receiving control or signaling messages from the PTC server 117.

For example, whenever a remote terminal receives an invitation to join a push-to-communicate service, the response to the invitation can include a radio quality characteristic. This can for example be based on other communications from the serving base station, on previous push-to-communicate services and/or the received invitation to join message.

The PTC server 117 can be a presence server which transmits presence messages to remote terminals. Thus, whenever a remote terminal belonging to the group becomes active or inactive, a presence message can be generated by the PTC server 117 and transmitted to the other remote terminals of the group. Whenever a remote terminal receives a presence message, it can acknowledge this by transmitting a response message comprising a radio quality characteristic.

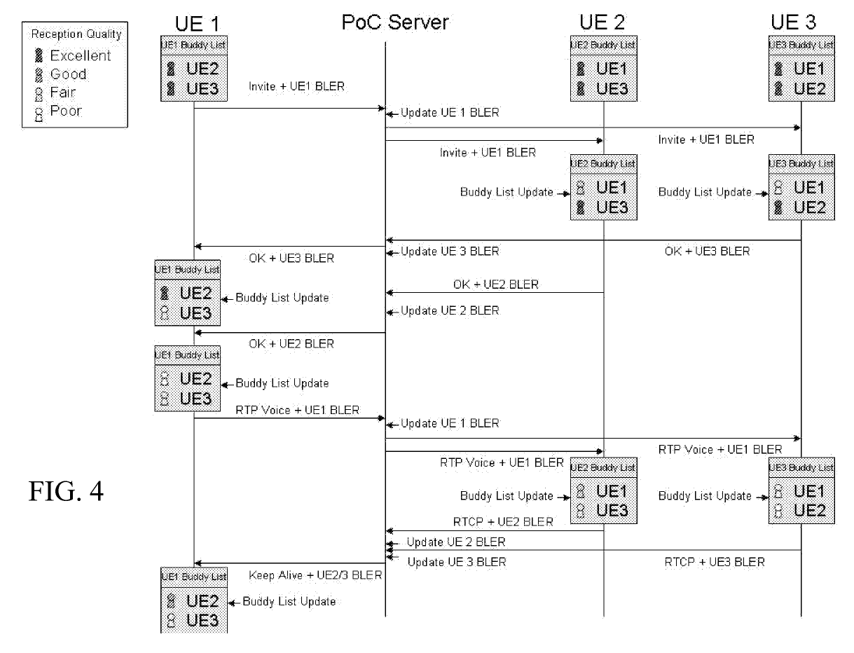

FIG. 4 illustrates an example of a push-to-communicate service in accordance with some embodiments of the invention. In the example, three remote terminals, denoted UE for user equipment, are involved in a push-to-communicate service. The push-to-communicate service is initiated by UE1 and joined by UE2 and UE3. A number of messages (indicated by arrows) are exchanged between the different UEs and the push-to-communicate server, denoted the PoC server for push-to-communicate over cellular server.

Whenever a message is communicated from a remote terminal to the server, a radio quality characteristic in the form of a BLER is included in the message. The radio quality characteristic received from one remote terminal is then forwarded to the other remote terminals of the group. When receiving the characteristics, the individual remote terminal modifies a visual representation of each of the other remote terminals in the group to reflect the received quality indication. In particular, the representations can be gradually faded to indicate the perceived reception quality at the other remote terminals.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A cellular communication system comprising:
means for supporting a push-to-communicate service for a group of remote terminals;
determining means for determining a radio quality characteristic for an air interface communication link of a first remote terminal of the group of remote terminals; the air interface communication link supporting the push-to-communicate service for the first remote terminal; and
first transmitting means for transmitting the radio quality characteristic to a second remote terminal of the group of remote terminals.

2. The cellular communication system of claim 1 wherein the first transmitting means is arranged to transmit the radio quality characteristic of the first remote terminal to all other remote terminals of the group of terminals.

3. The cellular communication system of claim 1 wherein the second remote terminal comprises:
storage means for storing data associated with the group of remote terminals; and
means for updating a stored characteristic for the second remote terminal in response to the radio quality characteristic.

4. The cellular communication system of claim 1 wherein the second remote terminal comprises means for presenting an indication of the radio quality characteristic to a user.

5. The cellular communication system of claim 1 wherein the second remote terminal comprises:
means for receiving radio quality characteristics from a plurality of the remote terminals of the group of remote terminals; and
means for presenting communication quality indications for each of the plurality of remote terminals, the communication quality indication being determined in response to the radio quality characteristics.

6. The cellular communication system of claim 1 wherein the first remote terminal comprises the determining means and means for including the radio quality characteristic in one of the group of; a user data packet, a signalling data packet a Session Initiation Protocol (SIP) data packet, a Real Time Protocol (RTP) data packet, and an idle mode link maintenance transmission.

7. The cellular communication system of claim 1 further comprising:
a push-to-communicate server comprising the means for supporting the push-to-communicate service and the first transmitting means, wherein the push-to communicate server comprises means for requesting the radio quality characteristic from the first remote terminal; and
wherein the first remote terminal comprises the determining means and second transmitting means for transmitting the radio quality characteristic to the push-to-communicate server.

8. The cellular communication system of claim 7 wherein the second remote terminal is arranged to transmit the radio quality characteristic in response to one of the group of; receiving an invitation to join a push-to-communicate service, and receiving a presence update message.

9. The cellular communication system of claim 1 wherein the radio quality characteristic comprises a radio link error rate parameter.

10. A method of operation in a cellular communication system, the method comprising:
supporting a push-to-communicate service for a group of remote terminals;
determining a radio quality characteristic for an air interface communication link of a first remote terminal of the group of remote terminals; the air interface communication link supporting the push-to-communicate service for the first remote terminal; and
transmitting the radio quality characteristic to a second remote terminal of the group of remote terminals.
